(19) United States
(12) Patent Application Publication
(10) Pub. No.: US 2024/0337887 A1
(43) Pub. Date: Oct. 10, 2024

(54) ACTIVE DICHROIC OPTICAL DEVICE AND MANUFACTURING METHOD THEREOF

(71) Applicant: Gwangju Institute of Science and Technology, Gwangju (KR)

(72) Inventors: Hyeon-Ho Jeong, Gwangju (KR); Gyu rin Kim, Incheon (KR); Young Min Song, Gwangju (KR); Jang-Hwan Han, Gwangju (KR); Soeun Ko, Gwangju (KR); Joo Hwan Ko, Jeongeup-si (KR)

(73) Assignee: Gwangju Institute of Science and Technology, Gwangju (KR)

(21) Appl. No.: 18/396,791

(22) Filed: Dec. 27, 2023

(30) Foreign Application Priority Data
Apr. 10, 2023 (KR) 10-2023-0047017

(51) Int. Cl. G02F 1/1514; G02F 1/155

(52) U.S. Cl. CPC G02F 1/1514; G02F 1/155

(57) ABSTRACT

An embodiment of the present invention provides an active dichroic optical device including a substrate; a first phase tunable material layer applied on the substrate; a metal nanostructure deposited on the first phase tunable material layer; and a second phase tunable material layer applied on the metal nanostructure, in which the first and second phase tunable material layers modulate the refractive index of light applied to the active dichroic optical device as external energy is applied and the metal nanostructure reflects, transmits, and scatters the resonance wavelength of the applied light.

### BACKGROUND OF THE INVENTION

### Field of the Invention

The present invention relates to an active dichroic optical device and a manufacturing method thereof, more particularly to an optical device that has secured technological competitiveness through the implementation of active dichroism using a multidirectional electrochromic metasurface and a manufacturing method thereof.

### Description of the Related Art

A dichroic device refers to an optical material or optical modulation device that separates white light by color (namely, wavelength) or modulates the phase of monochromatic light, and mainly attracting attention as a technology for application fields such as optical memory, optical encryption, and displays. However, existing technologies have static characteristics that only operate for a given color or phase, that is, cannot be controlled actively, so there is a limit to memory capacity, and adaptive control to changes in imaging or external environments (light brightness, color, and the like) is not possible. Hence, studies on dichroic devices that can be actively controlled are lively conducted, and methods of mechanically stretching flexible devices, methods of deforming structures using lasers, and methods using liquid crystals have recently been announced. However, there are limitations such as low process yield and performance (low color contrast) and difficulty in miniaturization.

As a technology that can improve the limited color contrast mentioned above and solve problems such as structure miniaturization and discoloration control ability, the present inventors have developed an active device fabricating technology that can be applied to displays or optical memory devices, and thus completed the present invention.

### SUMMARY OF THE INVENTION

The present invention has been devised to solve the above-described problems, and an embodiment of the present invention provides an active dichroic optical device.

Another embodiment of the present invention provides a method of manufacturing an active dichroic optical device.

Another embodiment of the present invention provides a glass panel.

Another embodiment of the present invention provides an optical security device.

The technical objects to be achieved by the present invention are not limited to the technical objects mentioned above, and other technical objects that are not mentioned will be clearly understood by those skilled in the art to which the present invention pertains from the description below.

As a technical means for achieving the above-mentioned technical objects, an aspect of the present invention provides an active dichroic optical device including a substrate; a metal nanostructure on the substrate; and an active refractive index modulation layer in a form of surrounding the metal nanostructure, in which the metal nanostructure reflects, transmits, and scatters a resonance wavelength of applied light and the active refractive index modulation layer modulates a resonance wavelength of the metal nanostructure by modulating a refractive index of light applied to the active dichroic optical device as external energy is applied.

The substrate may be a transparent electrode containing indium tin oxide (ITO), fluorine tin oxide (FTO) or indium zinc oxide (IZO).

The active refractive index modulation layer may contain at least one active refractive index modulation layer selected from the group consisting of conductive polymers (polyaniline (PANI) and PEDOT-PSS), metal alloy materials (Ge₂Sb₂SeXTe₅₋ₓ alloy (x is an integer from 0 to 5), Sb₂Se₃, and Sb₂S₃), and metal oxides (VO₂ and TiO₂).

The metal nanostructure may be at least one metal selected from the group consisting of gold, silver, copper, nickel, palladium, magnesium, and aluminum.

The metal nanostructure may be deposited to fill an area to be 25% to 50% of a total area of the active refractive index modulation layer.

The metal nanostructure may have a particle size of 1 to 30 nm.

The external energy may be derived from electricity, heat, or pressure.

Another aspect of the present invention is a method of manufacturing the active dichroic optical device, which includes a method of manufacturing a structure in which an active refractive index modulation layer is applied around a metal nanostructure. Examples of representative forms provide a method of manufacturing an active dichroic optical device, which includes coating a substrate with an active refractive index modulation layer; depositing a deposited metal nanostructure or metal nanoparticles on the active refractive index modulation layer; and coating the metal nanostructure with an active refractive index modulation layer.

In the step of coating a substrate with an active refractive index modulation layer, coating may be performed by a chemical reaction in a solution or electrodeposition.

In the step of depositing a deposited metal nanostructure on the active refractive index modulation layer, the substrate may be cooled and deposition may be performed by physical vapor deposition (PVD).

In the step of coating the metal nanostructure with an active refractive index modulation layer, the active refractive index tunable material may be applied in a form of surrounding a surface of the metal nanostructure.

As the metal nanostructure and the active refractive index modulation layer are sequentially stacked through separate processes, different colors may be exhibited in reflection, transmission, and scattering phases.

Another aspect of the present invention provides a glass panel including the active dichroic optical device.

Another aspect of the present invention provides an optical security device including a film including the active dichroic optical device; and a base substrate, in which a color of the film and a color of the base substrate are the same as each other and the color of the film changes as external energy is applied.

Still another aspect of the present invention provides an optical filter including a film including the active dichroic optical device; and a base substrate, in which a color temperature of light passing through the film is constantly maintained by applying external energy depending on a color temperature of an external light source.

### BRIEF DESCRIPTION OF THE DRAWINGS

FIGS. 1A and 1B are schematic diagrams expressing the principle and structure of an active dichroic optical device according to an embodiment of the present invention;

FIG. 2 illustrates a method of manufacturing an active dichroic optical device according to an embodiment of the present invention and a scanning electron microscope (SEM) image of the top and cross section of the manufactured device;

FIG. 3 is data showing structural characteristics of an active dichroic optical device according to an embodiment of the present invention depending on the deposition thickness of a metal nanostructure;

FIG. 4 illustrates plasmonic dichroism characteristics of an active dichroic optical device according to an embodiment of the present invention;

FIG. 5 is data showing electrochromic performance of an active dichroic optical device according to an embodiment of the present invention;

FIG. 6 is data showing electrochromic performance of an active dichroic optical device according to an embodiment of the present invention depending on the deposition thickness of a metal nanostructure;

FIG. 7 is data showing color modulation region expansion characteristics of an active dichroic optical device according to an embodiment of the present invention through stacking of a metal nanostructure and an active refractive index modulation layer;

FIG. 8 illustrates an application example of a glass panel including an active dichroic optical device according to an embodiment of the present invention;

FIG. 9 illustrates an application example of an optical security device including an active dichroic optical device according to an embodiment of the present invention; and

FIG. 10 illustrates an application example of a color temperature correction filter including an active dichroic optical device according to an embodiment of the present invention.

### DETAILED DESCRIPTION OF THE PREFERRED EMBODIMENTS

Hereinafter, the present invention will be described in more detail. However, the present invention can be implemented in various different forms, and the present invention is not limited to the embodiments described herein, and the present invention is only defined by the claims to be described later.

In addition, the terms used in the present invention are only used to describe specific embodiments and are not intended to limit the present invention. Singular expressions include plural expressions unless the context clearly dictates otherwise. Throughout the specification of the present invention, ‘including’ a certain component means further including other components rather than excluding other components unless specifically stated to the contrary.

Throughout the specification, when a part is said to be “connected (linked, in contact, bound)” with another part, this includes not only cases of being “directly connected” but also cases of being “indirectly connected” with another member in between. When a part is said to “include” a certain component, this means that the part may further include other components rather than exclude other components unless specifically stated to the contrary.

The terms used herein are only used to describe specific embodiments and are not intended to limit the invention. Singular expressions include plural expressions unless the context clearly dictates otherwise.

A first aspect of the present disclosure provides an active dichroic optical device including a substrate; an active refractive index modulation layer applied on the substrate; a metal nanostructure deposited on the active refractive index modulation layer; and an active refractive index modulation layer applied on the metal nanostructure; in which the metal nanostructure reflects, transmits, and scatters the resonance wavelength of applied light and the active refractive index modulation layer modulates the refractive index of light applied to the active dichroic optical device and modulates the resonance wavelength of the metal nanostructure as external energy is applied.

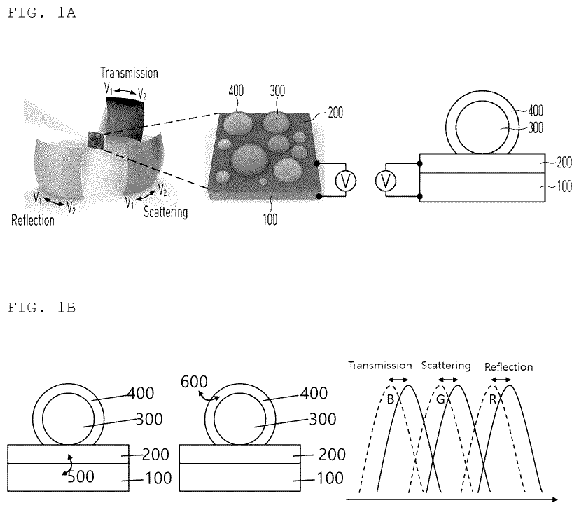

Hereinafter, the active dichroic optical device according to the first aspect of the present application will be described in detail. FIGS. 1A and 1B are schematic diagrams expressing the principle of the active dichroic optical device according to an embodiment of the present invention.

The implementation principle of the active dichroic optical device according to an embodiment of the present application may be broadly two. First, color is expressed using the localized surface plasmon resonance (LSPR) effect, which is an optical characteristic occurring in the structure of a metal nanostructure. The LSPR has the feature of reflecting, transmitting, and scattering a specific resonance wavelength when receiving white light typified by sunlight, and has the advantage of enabling sufficient visible color expression only with structure single layer configuration (at this time, meaning a metasurface having a thickness of 100 nm or less) of a metal nanostructure. At this time, when the material and shape of the structure (or metasurface) of the metal nanostructure and the refractive index of the surrounding medium is changed, modulation of the resonance wavelength (namely, changes in color) is possible.

Therefore, the second principle is that an active dichroic optical device can be implemented by forming an active layer that has changes in the refractive index in response to external energy such as electricity, heat, or pressure on the plasmonic structure surface.

The above-mentioned resonance conditions are as shown in Equation 1 below.

$${ε}_{r} ( {λ}^{*} ) = - χ {n}^{2} \qquad [ Equation 1 ]$$

εᵣ is the real part of the metal dielectric constant, λ* is the resonance wavelength, χ is the shape and size variable of the metal nanostructure, and n is the surrounding refractive index. In the present application, the resonance wavelength is controlled through χ modulation depending on the deposition thickness of the metal nanostructure and n modulation of the active refractive index modulation layer.

In a case where the active refractive index tunable material according to an embodiment of the present application is polyaniline, the double bond structure in the molecule changes by external power and electrolyte and this is illustrated in FIG. 1B. In this way, the wavelength of absorbed and scattered light can be modulated according to changes in external energy (particularly electricity).

Referring to FIG. 1A regarding the active dichroic optical device according to an embodiment of the present application, the front, back, and side of the active dichroic optical device express colors different from one another, as shown below.

[Equation 2]

Front+Back+ΔAbsorption−Side=100% (0)

Front:Reflection+ΔScattering (1)

Side:ΔScattering (2)

Back(BF):100%−Reflection−ΔAbsorption (3)

In the case of the front, color modulation will occur in the light having the wavelength that reflects the applied light to the front by considering the change in scattered light due to active plasmonics, that is, refractive index modulation. In the case of the back, color modulation will occur in the light having the wavelength that transmits the applied light by considering the reflected light and the change in absorbed light due to refractive index modulation. In the case of the side, only the modulation of the scattered light due to active plasmonics will be considered. In this way, the three surfaces can display colors of wavelengths different from one another, and this can be adjusted.

In an embodiment of the present application, as the substrate, any material that can be used in an optical device may be used without limitation, and the substrate may be indium tin oxide (ITO), fluorine tin oxide (FTO), indium zinc oxide (IZO), and the like, and may be preferably indium tin oxide (ITO).

In an embodiment of the present application, the active refractive index modulation layer may contain at least one active refractive index tunable material selected from the group consisting of conductive polymers (polyaniline (PANI) and PEDOT-PSS), metal alloy materials (Ge₂Sb₂SeXTe₅₋ₓ alloy (x is an integer from 0 to 5), Sb₂Se₃, and Sb₂S₃), and metal oxides (VO₂ and TiO₂), any active refractive index tunable material capable of modulating the refractive index by an electrical signal can be used without limitation, and preferably, the active refractive index modulation layer may be polyaniline (PANI). PANI, one material of the above-mentioned conductive polymers, is a material capable of large refractive index modulation of up to 0.5 or less in the visible light region even with a nanoscale thickness, and may have high utilization potential.

In an embodiment of the present application, the metal nanostructure may be at least one metal selected from the group consisting of gold, silver, copper, nickel, palladium, magnesium, and aluminum, any metal material that exhibits the above-described LSPR phenomenon may be used without limitation, but preferably, the metal nanostructure may be gold.

In an embodiment of the present application, the deposition thickness of the metal nanostructure may be 2 to 6 nm. In an embodiment of the present application, the metal nanostructure may have a particle size of 1 to 30 nm. As described above, nano-sized metal particles may undergo resonance and exhibit colors different from those previously exhibited. Resonance may be caused by changing the material shape characteristics and peripheral refractive index of such a metal nanostructure. From this point of view, in a case where the deposition thickness and particle size are less than the above-mentioned ranges, the metal nanostructure sufficiently fills only an area to be a too small fraction of the total area of the active refractive index modulation layer, so a sufficient color modulation effect cannot be obtained. In a case where the deposition thickness and particle size exceed the above-mentioned ranges, the particle size itself becomes too large and only optical characteristics due to scattering are observed even in the reflection and transmission regions.

In an embodiment of the present application, the metal nanostructure may be deposited to fill an area to be 25% to 50% of the total area of the active refractive index modulation layer. In a case where the area is less than the above-mentioned range, the metal nanostructure sufficiently fills only an area to be a too small fraction of the total area of the active refractive index modulation layer, so a sufficient color modulation effect cannot be obtained. In a case where the area exceeds the above-mentioned range, only optical characteristics due to scattering are observed even in the reflection and transmission regions because of excessive deposition of metal nanostructure.

In an embodiment of the present application, the external energy may be derived from electricity, heat, or pressure, and may be preferably to apply a voltage that induces a change in the refractive index of the active refractive index modulation layer, and more preferably, the external energy may be to apply a voltage of −0.2 to 1.0 V.

In an embodiment of the present application, a wider color modulation range may be obtained by stacking the metal nanostructure and two or more active refractive index modulation layers through separate processes. The process method for stacking may be methods well known in the art as well as the methods presented herein.

The active dichroic optical device according to an embodiment of the present application will be usefully utilized in any field that can utilize the device characteristics of the active dichroic optical device according to an embodiment of the present application, such as glass panels, smart glasses, smart windows, stained glass, optical memory devices, and optical security devices, but as will be described later, implementation examples into a glass panel and an optical security device will be additionally described to aid understanding.

A second aspect of the present application is a method of manufacturing the active dichroic optical device, which includes all types of manufacturing methods in which an active refractive index modulation layer is located around a metal nanostructure. Representatively, the manufacturing method may have the structure of an embodiment of the present application. Embodiments provide a method of manufacturing an active dichroic optical device, which includes coating a substrate with an active refractive index modulation layer; depositing a deposited metal nanostructure on the active refractive index modulation layer; and coating the metal nanostructure with an active refractive index modulation layer.

Detailed description of parts overlapping with the first aspect of the present application has been omitted, but the content described with respect to the first aspect of the present application can be applied equally even if the description is omitted in the second aspect.

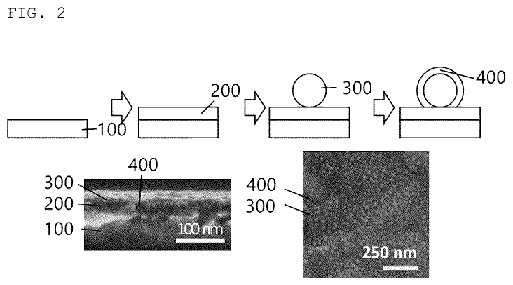

Hereinafter, the method of manufacturing an active dichroic optical device according to the second aspect of the present application will be described in detail. FIG. 2 schematically illustrates the method of manufacturing an active dichroic optical device according to an embodiment of the present invention.

First, in an embodiment of the present application, a step of coating a substrate with a first phase tunable material layer may be included. In an embodiment of the present application, in the step of coating a substrate with a first phase tunable material layer, coating or electrodeposition is performed by a chemical reaction in a solution. As the solvent of the above-described solution, any available solvent can be used without limitation as long as it can dissolve a precursor of the active refractive index tunable material or adsorb the precursor onto the substrate surface by an electric field. As the coating method as well, any coating method well known in the art can be used without limitation.

Next, in an embodiment of the present application, a step of depositing a deposited metal nanostructure on the active refractive index modulation layer may be included. In an embodiment of the present application, well-known methods can be used without limitation for the method of depositing a metal nanostructure, but in the step of depositing a deposited metal nanostructure on the active refractive index modulation layer, the substrate may be cooled and deposition may be performed by physical vapor deposition (PVD). In this case, the source of the metal nanostructure may be prepared and then sent to the substrate for deposition using an electron beam (E-beam) or inert gas.

Next, in an embodiment of the present application, a step of coating the metal nanostructure with an active refractive index modulation layer may be included. Coating methods well known in the art may be used without limitation for this coating method as well, but in an embodiment of the present application, in the step of coating the metal nanostructure with an active refractive index modulation layer, the active refractive index modulation layer may be applied in a form of surrounding the surface of the metal nanostructure.

A third aspect of the present application provides a glass panel including the active dichroic optical device.

Detailed description of parts overlapping with the first and second aspects of the present application has been omitted, but the contents described with respect to the first and second aspects of the present application can be applied equally even if the description is omitted in the third aspect.

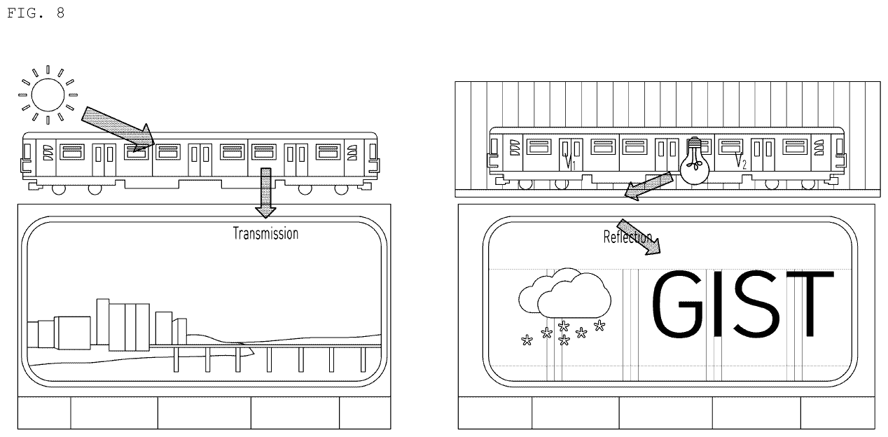

Hereinafter, the glass panel according to the third aspect of the present application will be described in detail. FIG. 8 illustrates an application example of the glass panel including the active dichroic optical device according to an embodiment of the present invention.

Due to the nature of public transportation such as subways, trains, and buses, the scene outside can be seen with the naked eye when these run outdoors, but it may not be able to see anything when these enter a dark place such as a tunnel. However, since a light source may exist inside the public transportation vehicles, dichroism due to reflection may be exhibited when the vehicles enter a tunnel. At this time, in a case of using the glass panel including the active dichroic optical device according to an embodiment of the present application, it is possible to exhibit active dichroism that displays information on the windows of public transportation with low power. In other words, the glass panel can be used as a smart panel that transmits light outdoors to provide the scenery outside and provides various kinds of information, such as advertisements, through active dichroism in dark places such as tunnels.

A fourth aspect of the present application provides an optical security device including a film including the active dichroic optical device; and a base substrate, in which the color of the film and the color of the base substrate are the same as each other and the color of the film changes as external energy is applied.

Detailed description of parts overlapping with the first to third aspects of the present application has been omitted, but the contents described with respect to the first to third aspects of the present application can be applied equally even if the description is omitted in the fourth aspect.

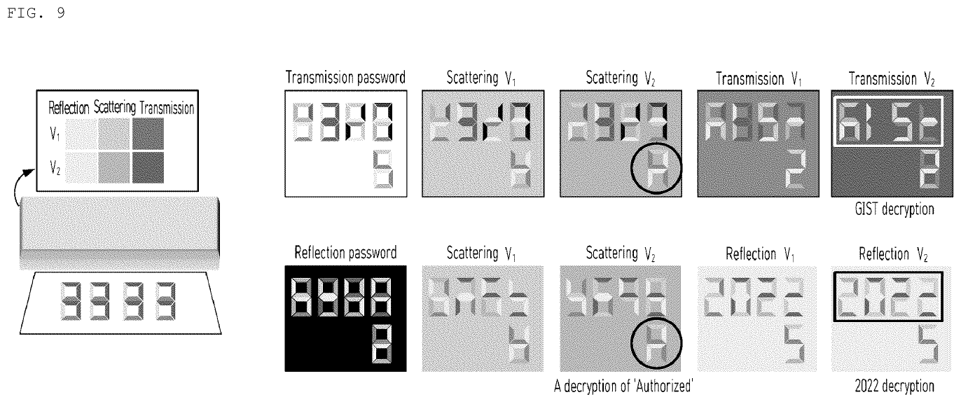

Hereinafter, the optical security device according to the fourth aspect of the present application will be described in detail. FIG. 9 illustrates an application example of an optical security device including an active dichroic optical device according to an embodiment of the present invention; and

In an embodiment of the present application, in a case where the color of the film and the color of the background (base substrate) are the same as each other, an optical security device can be implemented by utilizing the characteristic that nothing is visible to the user. The principle may be that decryption is impossible in a case where a sample created in a cipher is viewed without applying voltage, but the color of the film itself changes when a specific voltage is applied and certain characters can be thus recognized with the naked eye. The optical security device can be implemented such that it is possible to confirm that the encryption and decryption keys match through scattering and to recognize characters that appear in transmission/reflection depending on the background color.

A fifth aspect of the present application provides an optical filter including a film including the active dichroic optical device; and a base substrate, in which the color temperature of light passing through the film is maintained constant by applying external energy depending on the color temperature of the external light source.

Detailed description of parts overlapping with the first to fourth aspects of the present application has been omitted, but the contents described with respect to the first to fourth aspects of the present application can be applied equally even if the description is omitted in the fifth aspect.

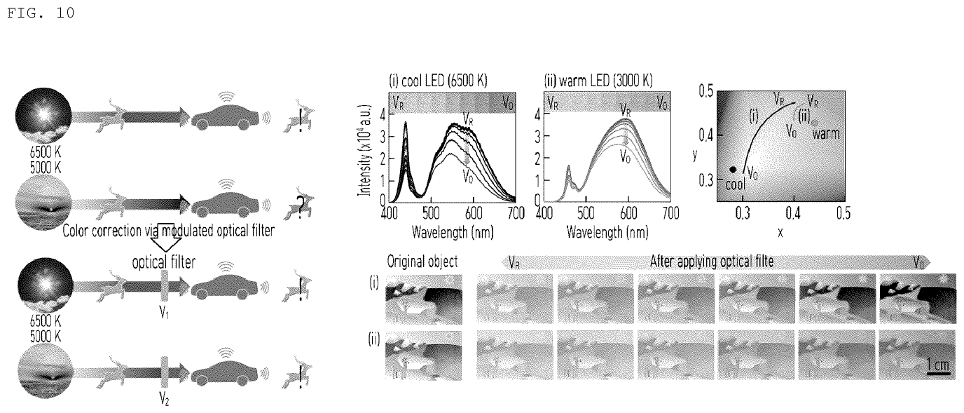

Hereinafter, the optical filter according to the fifth aspect of the present application will be described in detail. FIG. 10 illustrates an application example of a color temperature correction filter including an active dichroic optical device according to an embodiment of the present invention.

In an embodiment of the present application, the color of an object has the characteristic of changing depending on the color temperature of the light source, and such a characteristic is not a major problem for the human eye but affects computer vision through artificial intelligence. Therefore, the color of an object varies depending on the spectrum of the light source, which can often cause errors when a camera-based self-driving car recognizes objects.

In an embodiment of the present application, the optical filter of the present invention can maintain the color temperature of light passing through the film constantly by applying external energy depending on the color temperature of the external light source and thus can maintain the color of an object constantly regardless of the light source.

In an embodiment of the present application, light sources having different color temperatures have different intensity distributions depending on the wavelength to exhibit different colors. To solve this problem, filtering for wavelengths having large intensity differences is necessary. The optical filter of the present invention can correct two light sources having different color temperatures to have one color temperature by applying an appropriate external voltage to the dichroic filter. The optical filter can also maintain the color of an object the same regardless of the light source.

Hereinafter, Examples of the present invention will be described in detail so that those skilled in the art to which the present invention pertains can easily implement the present invention. However, the present invention can be implemented in various different forms and is not limited to Examples described herein.

### Fabrication Example 1: Fabrication of Active Dichroic Optical Device

An ITO substrate (15×15 mm) prepared as a substrate was coated with aniline prepared at a concentration of 2 mM and a content of 2.5 mL as a precursor for an active refractive index modulation layer (PANI) by the method of solution chemistry in which a synthesis reaction was conducted in a liquid. Alternatively, the substrate was coated with aniline that was prepared at a concentration of 15 mM and a content of 13.7 μL and mixed with a solution of nitric acid at a concentration of 2 M and a content of mL by an electrodeposition method using cyclic voltammetry in a voltage range of −0.2 V to 0.9 V. Gold as a metal nanostructure was prepared in the form of a source for an electron beam deposition instrument, and in order to form metal nanostructure layers having the following deposition thicknesses, deposition was carried out by a physical vapor deposition method in which part of the substrate was covered with a screen and then gold was deposited while performing rotation at a certain angle. Thereafter, aniline was prepared at a concentration of 2 mM and a content of 2.5 mL as a precursor for the second phase tunable material (PANI) layer, and applied to the formed metal nanostructure layer in a thickness of 10 nm for 8 hours by the method of solution chemistry to fabricate each active dichroic optical device.

### Example 1: Observation of Structure of Active Dichroic Optical Device Depending on Deposition Thickness

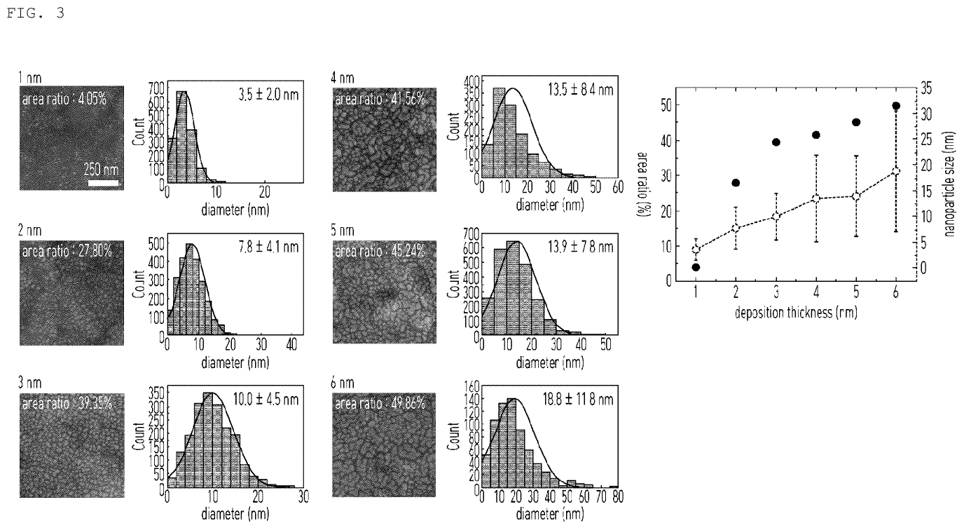

FIG. 3 is data showing structural characteristics of the active dichroic optical device according to an embodiment of the present invention depending on the deposition thickness of the metal nanostructure.

Specifically, FIG. 3 illustrates SEM images of the observed surface depending on the deposition thickness of metal nanostructures, the particle size distributions of metal nanostructures, and the fill fractions of metal nanostructures in a unit area, and the right side of FIG. 3 illustrates a graph showing these.

Referring to FIG. 3, in a case where the deposition thickness satisfies 2 to 6 nm, it has been found that deposition is performed to fill an area that is 50% or less of the total area of the first phase tunable material layer and is proper (about 20% or more) to cause a certain degree of resonance.

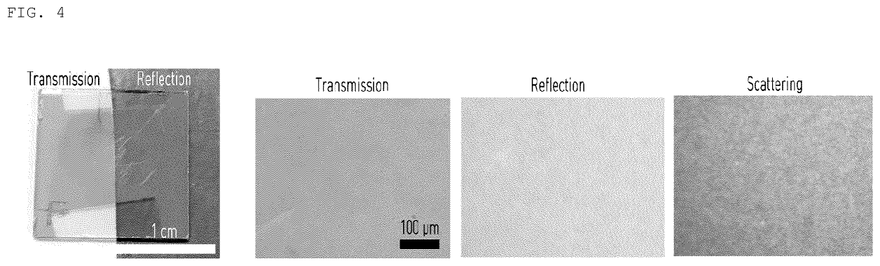

FIG. 4 is a photograph showing the dichroic characteristics of the optical device fabricated under the condition of a deposited metal nanostructure thickness of 4 nm. Referring to FIG. 4, it can be clearly seen that different colors are exhibited by transmission and reflection.

### Example 2: Observation of Plasmonic Dichroism

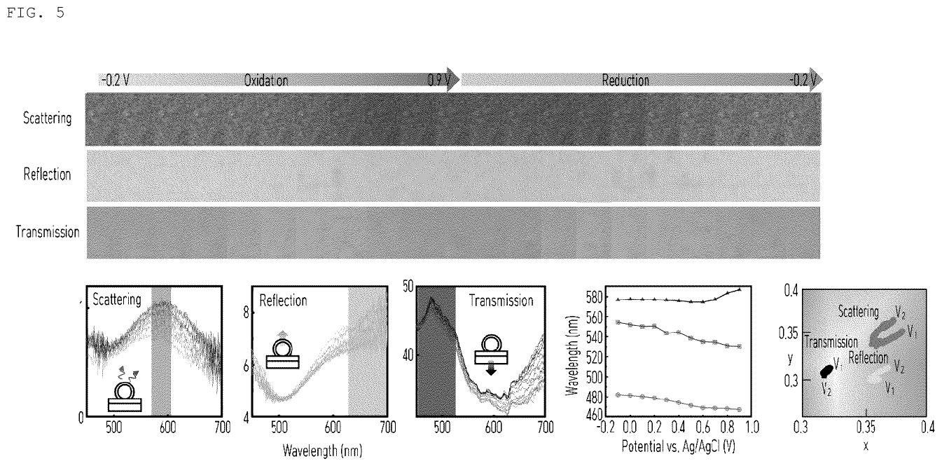

FIG. 5 illustrates the results of observing the plasmonic dichroism of the active dichroic optical device (deposition thickness of 4 nm) according to an embodiment of the present invention. Referring to FIG. 5, it has been confirmed that the colors by transmission, reflection, and scattering are all expressed differently.

### Example 3: Observation of Electrochromic Performance

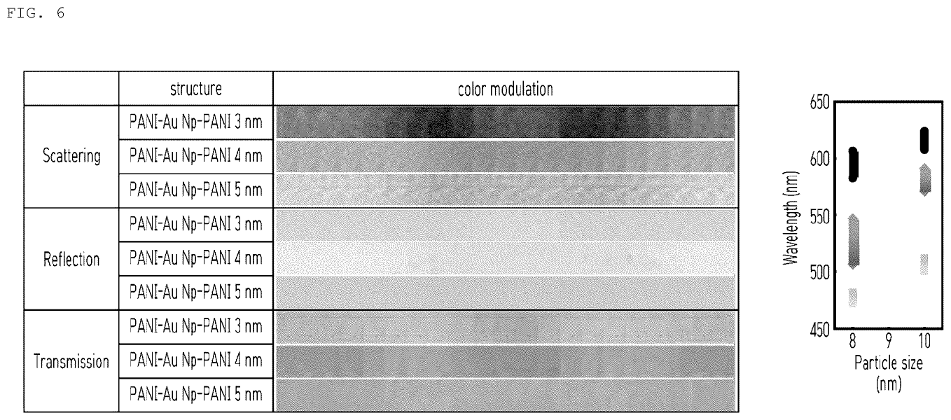

FIGS. 5 and 6 are data showing electrochromic performance of the active dichroic optical device according to an embodiment of the present invention.

Specifically, FIG. 5 illustrates the results of examining color changes by each of scattering, reflection, and transmission depending on the voltage range applied. According to FIG. 5, it can be seen that green, red, and blue colors are exhibited by scattering, reflection, and transmission, respectively, and the colors can be changed depending on the applied voltage and can be reversibly adjusted. The bottom of FIG. 5 illustrates the optical characteristics of the active dichroic optical device according to an embodiment of the present invention. Referring to the bottom of FIG. 5, it can be seen that the light responsivity due to plasmonic resonance is maximum and minimum in the wavelength ranges of colors exhibited by scattering, reflection, and transmission. When the resonance wavelengths of scattering, reflection, and transmission depending on the voltage are graphed, it can be seen that modulation by scattering, reflection, and transmission continuously occurs at wavelengths different from one another. When the modulation ability of the active dichroic optical device according to an embodiment of the present invention is expressed in the CIE 1931 color space, it can be seen that all wavelengths of visible light are expressed.

FIG. 6 illustrates the results of observing the color change of the active dichroic optical device according to an embodiment of the present invention depending on the deposition thickness and voltage application in each of scattering/reflection/transmission. Referring to the left side of FIG. 6, it has been confirmed that a large color change can be induced by changing the deposition thickness and that a certain level of color change can be caused depending on the voltage. It can be seen from the right side of FIG. 6 that all wavelengths of visible light can be expressed by adjusting the size of deposited metal nanostructure.

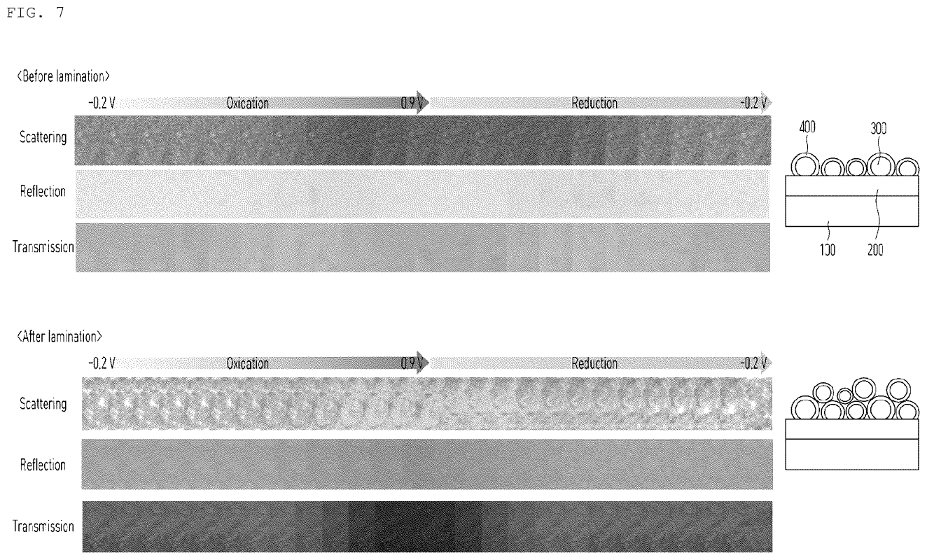

FIG. 7 illustrates the results of observing the color change of the active dichroic optical device according to an embodiment of the present invention due to stacking of a metal nanostructure and an active refractive index modulation layer. Referring to FIG. 7, it has been confirmed that the modulated color range can be changed through stacking.

According to an embodiment of the present invention, it is possible to provide an optical device having a dichroic modulation function in which reflection and transmission colors, including existing scattering-based color modulation, are expressed differently in the visible light region. This characteristic was not able to be realized using existing technologies that predominantly express color through scattering.

According to an embodiment of the present invention, the colors of red, green, and blue can be expressed with a single structure having a thickness of 100 nm or less, further characteristics that enable color modulation can be exhibited, and these characteristics can be utilized in applications such as glass panels and optical security devices.

The effects of the present invention are not limited to the effects described above, and should be understood to include all effects that can be inferred from the configuration of the invention described in the description or claims of the present invention.

The foregoing description of the present invention is for illustrative purposes only, and those skilled in the art to which the present invention pertains will understand that the present invention can be easily modified into another specific form without changing its technical idea or essential features. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

What is claimed is:

1. An active dichroic optical device comprising:
a substrate;
a metal nanostructure deposited on the substrate; and
an active refractive index modulation layer in a form of surrounding the metal nanostructure,
wherein the metal nanostructure reflects, transmits, and scatters a resonance wavelength of applied light, and
the active refractive index modulation layer controls a resonance wavelength of the metal nanostructure through refractive index modulation as external energy is applied.

2. The active dichroic optical device according to claim 1,
wherein the substrate is a transparent electrode containing indium tin oxide (ITO), fluorine tin oxide (FTO) or indium zinc oxide (IZO).

3. The active dichroic optical device according to claim 1,
wherein the active refractive index modulation layer contains at least one active refractive index tunable material selected from the group consisting of conductive polymers (polyaniline (PANI) and PEDOT-PSS), metal alloy materials (Ge₂Sb₂SeXTe₅₋ₓ alloy (x is an integer from 0 to 5), Sb₂Se₃, and Sb₂S₃), and metal oxides (VO₂ and TiO₂).

4. The active dichroic optical device according to claim 1,
wherein the metal nanostructure is at least one metal selected from the group consisting of gold, silver, copper, nickel, palladium, magnesium, and aluminum.

5. The active dichroic optical device according to claim 1,
wherein the metal nanostructure is deposited to fill an area to be 25% to 50% of a total area of the active refractive index modulation layer.

6. The active dichroic optical device according to claim 1,
wherein the metal nanostructure has a particle size of 1 to 30 nm.

7. The active dichroic optical device according to claim 1,
wherein the external energy is derived from electricity, heat, or pressure.

8. A method of manufacturing the active dichroic optical device according to claim 1, comprising:
coating a substrate with an active refractive index modulation layer;
depositing a metal nanostructure on the active refractive index modulation layer; and
coating the metal nanostructure with an active refractive index modulation layer.

9. The method of manufacturing an active dichroic optical device according to claim 8,
wherein the step of coating a substrate with an active refractive index modulation layer is carried out through coating or electrodeposition by a chemical reaction in a solution.

10. The method of manufacturing an active dichroic optical device according to claim 8,
wherein in the step of depositing a deposited metal nanostructure on the active refractive index modulation layer, the substrate is cooled and deposition is performed by physical vapor deposition (PVD).

11. The method of manufacturing an active dichroic optical device according to claim 8,
wherein in the step of coating the metal nanostructure with an active refractive index modulation layer, the active refractive index tunable material is applied in a form of surrounding a surface of the metal nanostructure.

12. A glass panel comprising the active dichroic optical device according to claim 1.

13. An optical security device comprising:
a film including the active dichroic optical device according to claim 1; and
a base substrate,
wherein a color of the film and a color of the base substrate are the same as each other, and
the color of the film changes as external energy is applied.

14. An optical filter comprising:
a film including the active dichroic optical device according to claim 1; and
a base substrate,
wherein a color temperature of light passing through the film is constantly maintained by applying external energy depending on a color temperature of an external light source.
